(19) United States
(12) Patent Application Publication
(10) Pub. No.: US 2016/0147774 A1
(43) Pub. Date: May 26, 2016

(54) SYSTEM AND METHOD FOR DATA VISUALIZATION

(71) Applicant: Cisco Technology, Inc., San Jose, CA (US)

(72) Inventor: Melinda XIAO-DEVINS, Fremont, CA (US)

(21) Appl. No.: 14/548,335

(22) Filed: Nov. 20, 2014

(51) Int. Cl. G06F 17/30

(52) U.S. Cl. CPC G06F 17/30064; G06F 17/30044; G06F 17/3005

(57) ABSTRACT

In one embodiment having an apparatus including a database including a collection of data relating to events recorded over time, and a user interface for displaying the data in the database, the user interface including a first timeline on which data from the database is presented graphically in a time-ordered fashion, the first timeline having a first length, and a second timeline on which a subset of the data presented on the first timeline is presented in an expanded graphical fashion, the second timeline having a second length, a mechanism for selecting a time range of data which is displayed on the first timeline to be displayed on the second timeline, wherein the second length greater than the length of a portion of the first timeline which displays the selected time range of data. Related systems, apparatus, and methods are also described.

### FIELD OF THE INVENTION

The present invention generally relates to ways to present data on timelines.

### BACKGROUND OF THE INVENTION

Some software packages present event related data as a timeline, so that the data is presented in a chronological sequence. The chronological sequence enables a viewer of the timeline to quickly see and understand temporal relationships between the events. The timeline typically displays data about events in a given range of time. The timeline in these software packages is often used to allow quick access to data concerning events displayed on the timeline.

### BRIEF DESCRIPTION OF THE DRAWINGS

The present invention will be understood and appreciated more fully from the following detailed description, taken in conjunction with the drawings in which:

FIG. 1 is a partially block diagram, partially pictorial illustration of an apparatus comprising a graphical user interface having data displayed on two timelines;

FIG. 2A is a simplified pictorial illustration of a first embodiment of the graphical user interface of FIG. 1;

FIG. 2B is a detail of the full range timeline and the detail range timeline in the window of FIG. 2A;

FIG. 3A is a simplified pictorial illustration of a second embodiment of the graphical user interface of FIG. 1;

FIG. 3B is a detail of the full range timeline and the detail range timeline in the window of FIG. 3A;

FIG. 4A is a simplified pictorial illustration of a third embodiment of the graphical user interface of FIG. 1;

FIG. 4B is a detail of the full range timeline and the detail range timeline in the window of FIG. 4A; and

FIG. 5 is a flowchart diagram of a method for implementing an embodiment of the graphical user interface of FIG. 1.

### DESCRIPTION OF EXAMPLE EMBODIMENTS

### Overview

An apparatus and method are described, the apparatus and method including a database including a collection of data relating to events recorded over time, and a user interface for displaying the data in the database, the user interface including a first timeline on which data from the database is presented graphically in a time-ordered fashion, the first timeline having a first length, and a second timeline on which a subset of the data presented on the first timeline is presented in an expanded graphical fashion, the second timeline having a second length, a mechanism for selecting a time range of data which is displayed on the first timeline to be displayed on the second timeline, wherein the second length is greater than the length of a portion of the first timeline which displays the selected time range of data. Related systems, apparatus, and methods are also described.

### Exemplary Embodiments

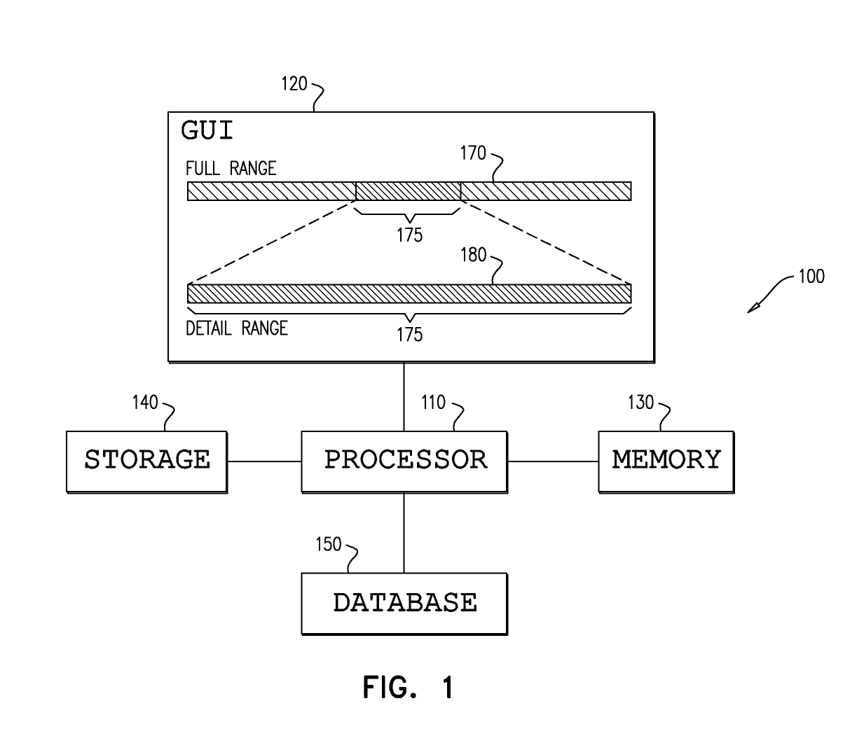

Reference is now made to FIG. 1, which is a partially block diagram, partially pictorial illustration of an apparatus comprising a graphical user interface (GUI) 120 having data displayed on two timelines 170, 180. The apparatus may be comprised in any device with computing power which operates appropriate software. For example, and without limiting the generality of the foregoing, the device may comprise a desktop computer, a tablet computer, a handheld device, or other appropriate system. Alternatively, the device may be a remote server and a user interacts with the remote server device via a remote user interface. A system 100 of FIG. 1 comprises a computer implemented system. The computer implemented system comprises at least one processor 110 and may comprise more than one processor 110. One of the processors 110 may be a special purpose graphics processor operative to display the GUI 120 having data displayed on two timelines as described herein. Before turning to the GUI 120, other elements of the system 100 depicted in FIG. 1 are now described.

The system 100 comprises non-transitory computer-readable storage media (i.e. memory) 130. The memory 130 may store instructions, which the at least one processor 110 may execute, in order to display the graphical user interface 120 described herein.

The system 100 also comprises a storage unit 140, which is to say long term memory, such as, and without limiting the generality of the foregoing, a hard disk drive, flash memory, or other appropriate media for long term storage of data.

The system 100 also typically comprises other standard hardware and software which are not depicted. For example, communications between components of the system 100 may be facilitated though a dedicated communications bus, wirelessly, or via any other appropriate mechanism. Typically, the system 100 comprises drivers, communications ports and protocols, other input and output mechanisms, and so forth, as are well known in the art.

The at least one processor 110 is also in communication with a database 150. The database 150 comprises a collection of data relating to events recorded over time. For example, the database 150 may be a database of video elements, such as streamed video for a security monitoring system. Alternatively, and more generally, the database 150 may be a database of records of events which occur over time. The records of events (i.e. the data) stored in the database can be anything which can be stored in a database and displayed in a chronological order, such as, but without limiting the generality of the foregoing, recorded video or metadata (sometimes having gaps), or motion triggered events, as is known in the art. The database 150 may store the data records, and may extract metadata concerning the data records for storage relating to the data records. Alternatively, the processor 110, or a different processor may extract the metadata concerning the data.

Turning back to the discussion of the GUI 120, at least one aspect of the GUI 120 is depicted in detail in FIG. 1. The GUI 120 comprises two timelines: a full range timeline 170 and a detail range timeline 180. Timelines, as is well known in the art, are chronologically arranged representations of events within a particular epoch. The full range timeline 170 presents a full time-range of records stored in the database 150, the records being graphically time-ordered along the length of the full length timeline 170.

The GUI 120 enables the user to select a time range 175 from the full range timeline 170. The selected time range 175, which comprises a subset of the data presented on the full range timeline 170 is presented, thereafter, in a zoomed-in fashion on the detail range timeline 180. In a typical embodiment, the length of the detail range timeline 180 is the same length as the length of the full range timeline 170. However, the detail range timeline 180 represents a subset of the full range 170 in terms of time duration.

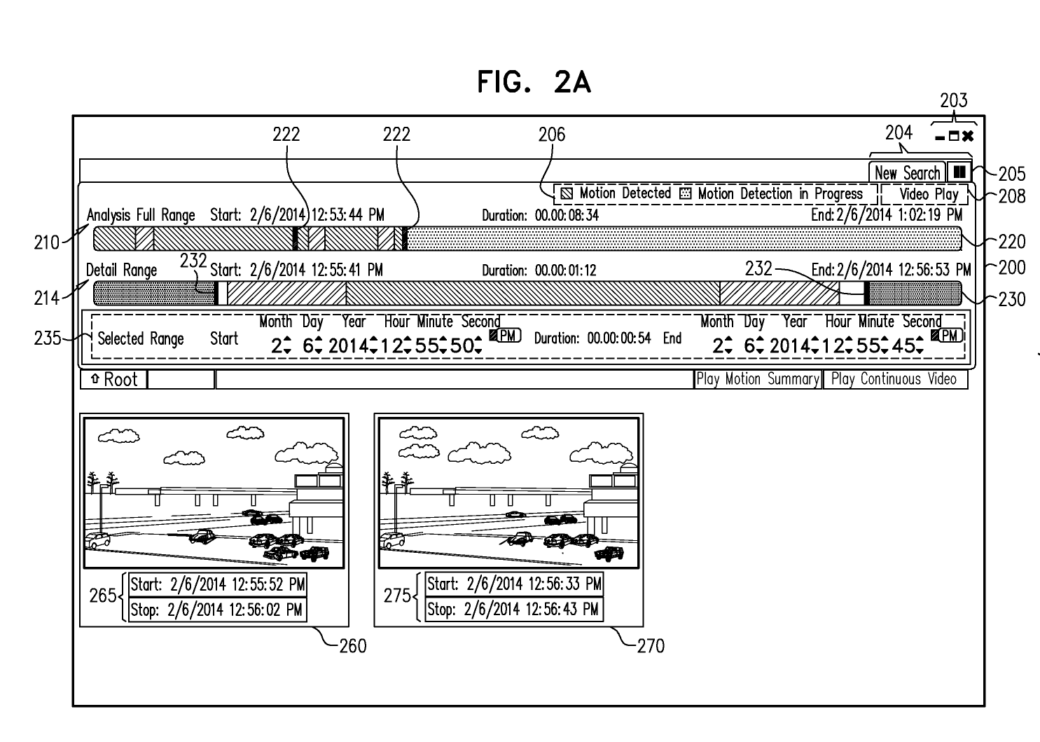

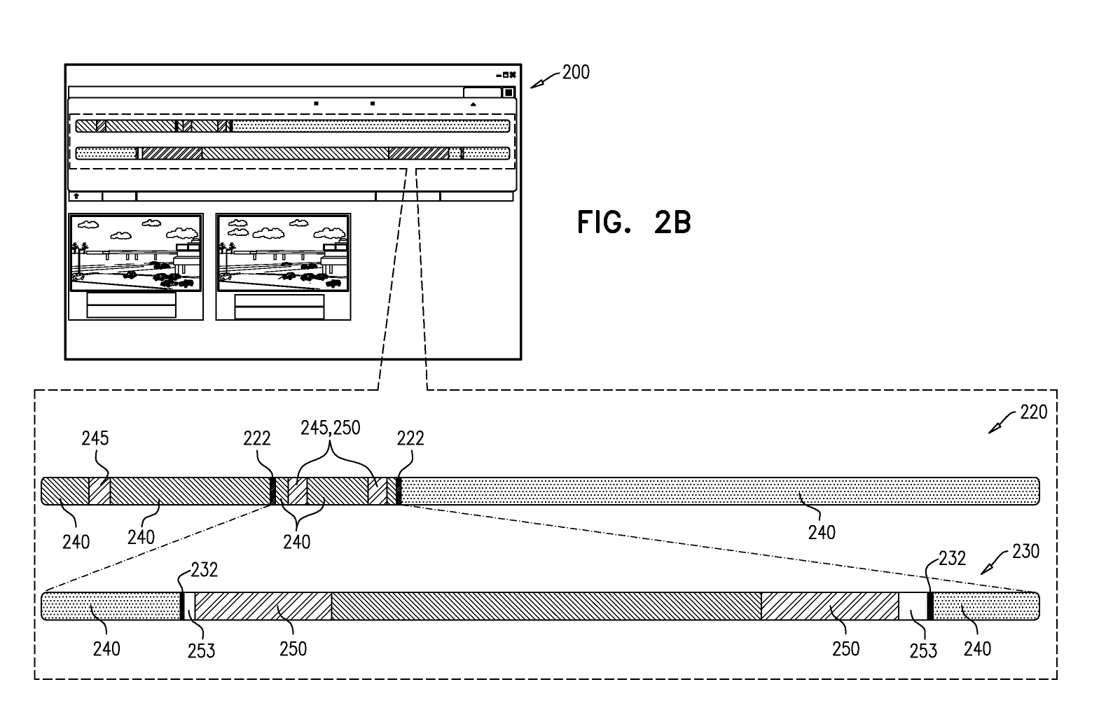

Reference is now made to FIG. 2A, which a simplified pictorial illustration of a first embodiment of the graphical user interface 120 of FIG. 1. FIG. 2A shows a window 200 which may be displayed on a computer display. The window 200 is depicted with typical components, common to many windows implemented as part of a graphical user interface. For example, the window 200 is depicted with standard user interface components 203 to minimize, maximize and close the window 200, as are known in the art. Additionally, the window also has an interface enabling opening a new tab (not depicted), starting a new search 204, or pausing playing video 205. A legend 206 relates to shading of items appearing in the full range timeline 220 and the detail range timeline 230. For example, events in the two timelines where motion detection is indicated will have the shading pattern (or color) indicated by the square appearing in the legend 206 before the words “Motion Detected”. Similarly, events where motion detection is presently in progress in the two timelines will have the same shading pattern (or color) indicated by the square appearing in the legend 206 before the words “Motion Detection in Progress”.

Two timelines, i.e. full range timeline 220 and detail range timeline 230 appear in the window 200, corresponding, respectively, to the full range timeline 170 and the detail range timeline 180 of FIG. 1. In some embodiments, the two timelines appearing in the window 200 are visually associated. For example, items appearing in both timelines will be depicted similarly, with a similar color scheme. A graphical representation of an event in the two timelines 220, 230 will appear longer on the detail range timeline 230 than on the full range timeline 220, in proportion to the percentage of the length of the full range timeline 220 represented on the detail range timeline 230. By way of example, if the detail range timeline 230 is displaying only 10% of the time range of the full range timeline 220, then events will appear to be around ten times larger on the detail range timeline 230 than they are displayed on the full range timeline 220.

It is appreciated that motion detection takes time. As a motion detection engine (not depicted) runs, the graphical user interface 120 of FIG. 1 will present the progress. In FIG. 2A, the left side of the full range timeline 220 is shaded (colored) to indicate that motion detection has already occurred (i.e. a small segment of stripes representing a motion event is shown). The right side of the full range timeline 220 is shaded (colored) to indicate that motion detection is still in progress. There are no motion events indicated in the portion of the timeline for which motion detection is still in progress, as the motion detection engine has not yet processed this part of the data.

An additional feature which may be implemented in some embodiments entails drawing the full range timeline 220 with a higher opacity except in the region of the full range timeline 220 represented on the detail range timeline 230. Referring back briefly to FIG. 1, by way of example, full range timeline 170 would be drawn in the window 200 with a higher opacity than the selected time range 175. Due to limitations inherent in the accompanying drawings, selected time range 175 is not drawn in full range timeline 170 with a lower opacity than the remainder of full range timeline 170. Detail range timeline 180, showing the selected time range 175 is also not drawn with the same lower opacity as the selected time range 175 appears in the full range timeline 170. However, on as software on a screen, as opposed to a line drawing on paper, such a visual effect may easily be achieved.

Returning to the discussion of FIG. 2A, a first information area 210 provides information about the data presented on the full range timeline 220. In the example provided in FIG. 2A, the starting date and time; the duration; and the ending date and time of the data represented in the full range timeline 220 is provided.

The full range timeline 220 has two sliders 222 which can be used by the user, for instance by dragging each of the two sliders 222 along the full range timeline 220, to indicate a selected the time range (such as time range 175 of FIG. 1) to be displayed on the detail range timeline 230. A second information area 214 provides information about the data presented on the detail range timeline 230. In the example provided in FIG. 2A, the starting date and time; the duration; and the ending date and time of the data represented in the detail range timeline 230 are provided. In this example depicted in FIG. 2A, the user selects a start and end time to retrieve the thumbnail representation of the motion event. There are two sliders 232 on the detail range timeline 230 which allow the user to select a time range, as indicated by “Selected Range” start, end time and duration 235. The user interface in window 200 also enables the user to fine tune the selected time by typing an exact time, or stepping through recorded video one second at a time. It is appreciated that although the full range timeline 220 indicates a duration of eight minutes and thirty four seconds, in practice the full range timeline 220 may present data over a much longer duration, possibly as long as several months.

Reference is now additionally made to FIG. 2B, which is a detail of the full range timeline 220 and the detail range timeline 230 in the window 200 of FIG. 2A. Because of the large number of elements presented in FIG. 2A, FIG. 2B is presented in order to prevent FIG. 2A from being overcrowded with item numbers.

As was noted above, the user is able to select a time range from the full range timeline 220, and this time range will be the range represented in the detail range timeline 230. By way of example, the full range timeline 220 shows events in a video system, the events being video frames in which motion is occurring. It is appreciated that when there is a recording gap, i.e. missing video that may be caused because a camera was inoperative or a network was down, then no indication of the presence of video will appear in the full range timeline 220. In those cases there will be gaps in the data (i.e. video frames) or metadata presented on the timeline. By way of example, the metadata may include luminance values of the recorded video frames (and, therefore, if no video frames are recorded, there will be no metadata). Alternatively, if there is a facial recognition system operating on the recorded video, the presence of a face, may invoke recording details of the face (such as its' owner's identity; or the hair color of the face; and so forth) in the metadata.

The full range timeline 220 has some regions for which motion detection is in progress 240. Other regions 245 are regions in which motion has been detected. The detail range timeline 230 shows details which are in the range between the two sliders 222 on the full range timeline 220. Two motion events 250 are shown in both the full range timeline 220 and the detail range timeline 230. Gaps 253, where there are no events (e.g. motion events 250) or for which no metadata has been recorded are indicated by a lack of color/hash pattern.

Returning to the discussion of FIG. 2A, two video frames 260 and 270, which are thumbnail images or snap shots of the video frame at the time of motion detection (i.e. “a motion event”), are shown corresponding to the two motion events 250. Additional details, such as the starting and ending times of the video are also shown for each of the video frames (i.e. thumbnails) 260 and 270. Additional information (not depicted), such as which video camera recorded these video thumbnails 260 and 270 might also be made available. It is appreciated that the thumbnail images are snapshots of the time in the recorded video when motion is detected. Each such motion event has a motion start time and a motion stop time (i.e. the times of the beginning and end of the event). The snapshots 260, 270 are produced at the motion start time, and a motion start stamp and motion stop stamp 265, 275 is displayed beneath the snapshot images 260, 270. By sliding the two sliders 232 on the detail range timeline 230, the user is able to view the thumbnails, such as thumbnail 260 and thumbnail 270. By selecting one of the thumbnails 260, 270 and pressing Video Play 208, the user may view a recorded video clip associated with the thumbnails 260, 270.

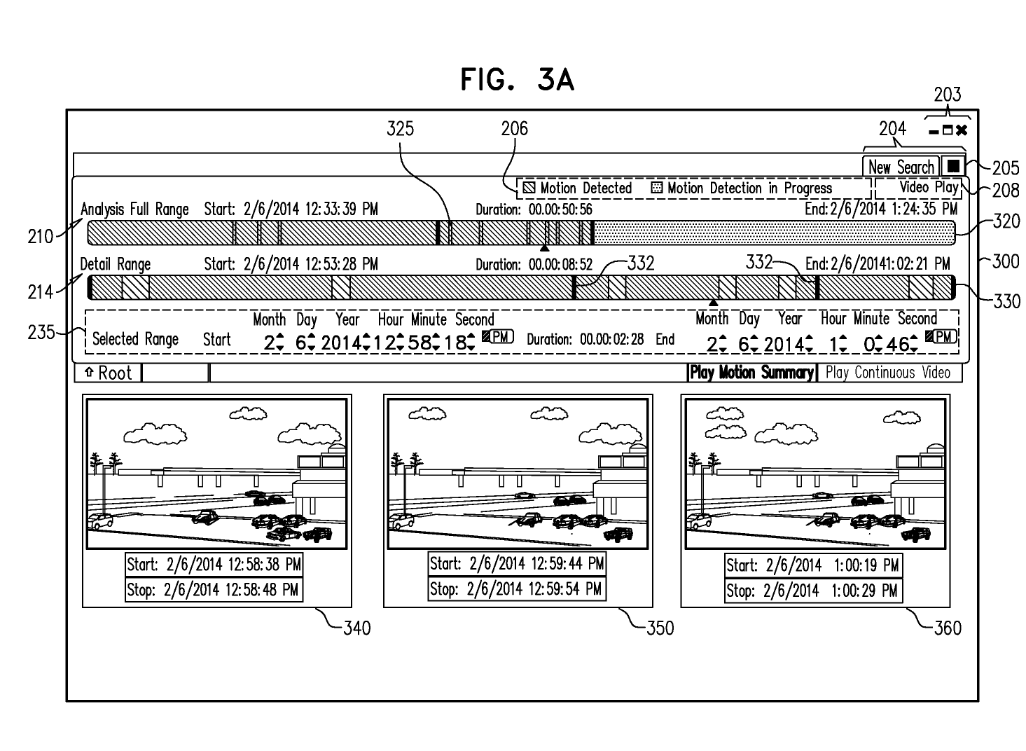

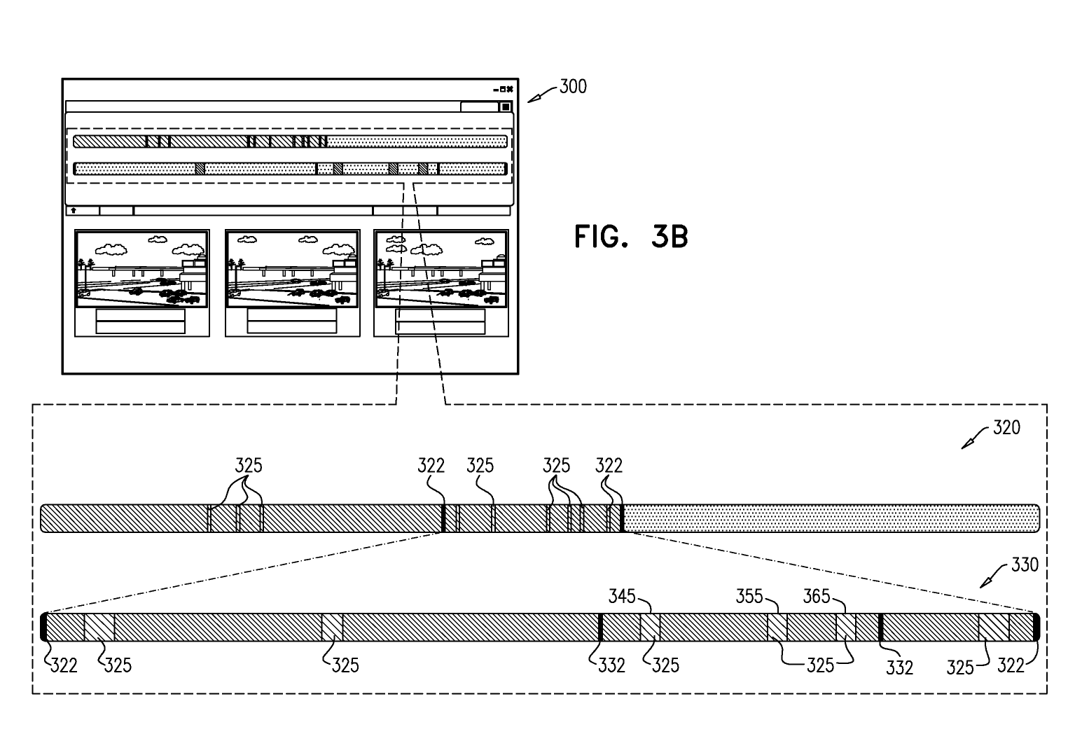

Reference is now made to FIGS. 3A and 3B. FIG. 3A is a simplified pictorial illustration of a second embodiment of the graphical user interface of FIG. 1. FIG. 3B is a detail of the full range timeline 320 and the detail range timeline 330 in the window of FIG. 3A. Elements appearing in FIGS. 3A and 3B which were already discussed in FIGS. 2A and 2B and are not relevant to the particular embodiment to be the discussed with reference to FIGS. 3A and 3B, for the sake of brevity, are not mentioned in the following discussion of FIGS. 3A and 3B. In the full range timeline 320 of FIGS. 3A and 3B, a multiplicity of motion events 325 are shown. A time range in which a group of six of the motion events 325 of the multiplicity of motion events 325 are selected and bound by sliders 322, and displayed as well on the detail range timeline 330. A second time range on the detail range timeline 330 is then further selected using two sliders 332, so that three thumbnails, 340, 350, and 360 now appear in the lower portion of the window 300. Each of the three thumbnails, 340, 350, and 360 corresponds, respectively, to one of the motion events 345, 355, and 365 in the selected time range of the detail range timeline 330. This enables using the full range timeline 320 to zoom-in in a gross fashion to areas of high frequency data, and then using the two sliders 332 on the detail range timeline 330 it is possible to focus on areas of particular interest, enabling further analysis.

It was mentioned above that there may be variation in opacity the display of the selected potion of the full range timeline 320 and the non-selected portion of the full range timeline 320, in order to provide visual clues to the user. In FIG. 3A, the selected portion of the full range timeline 320 is also not depicted with greater opacity than the non-selected portion of the full range timeline 320.

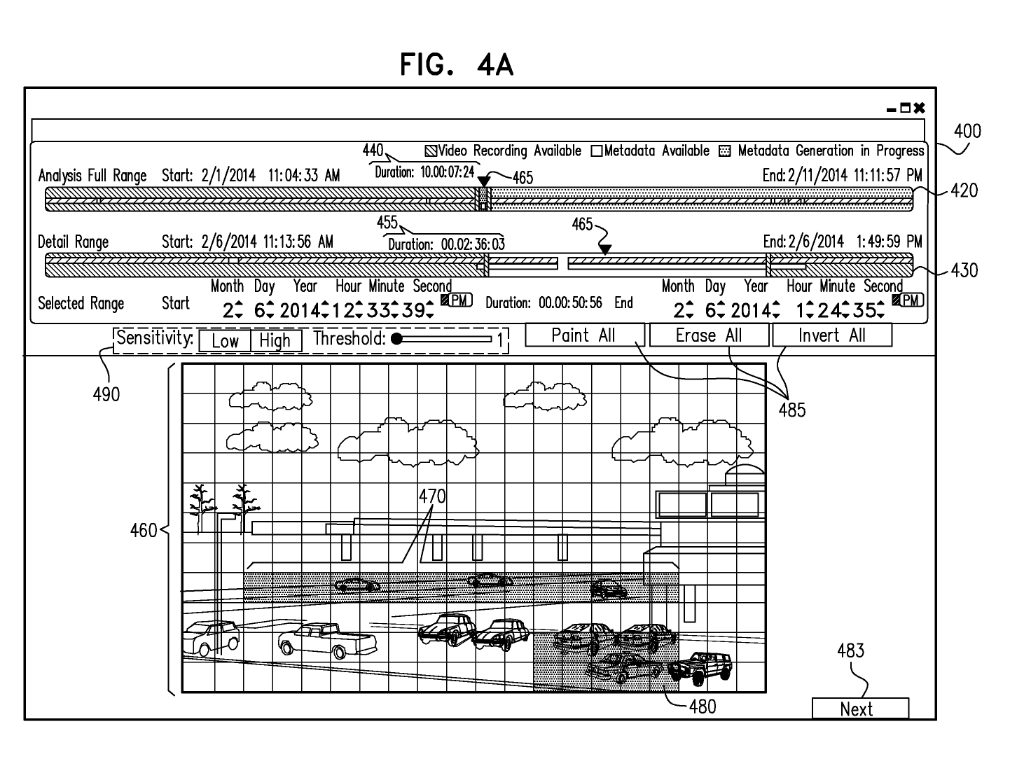

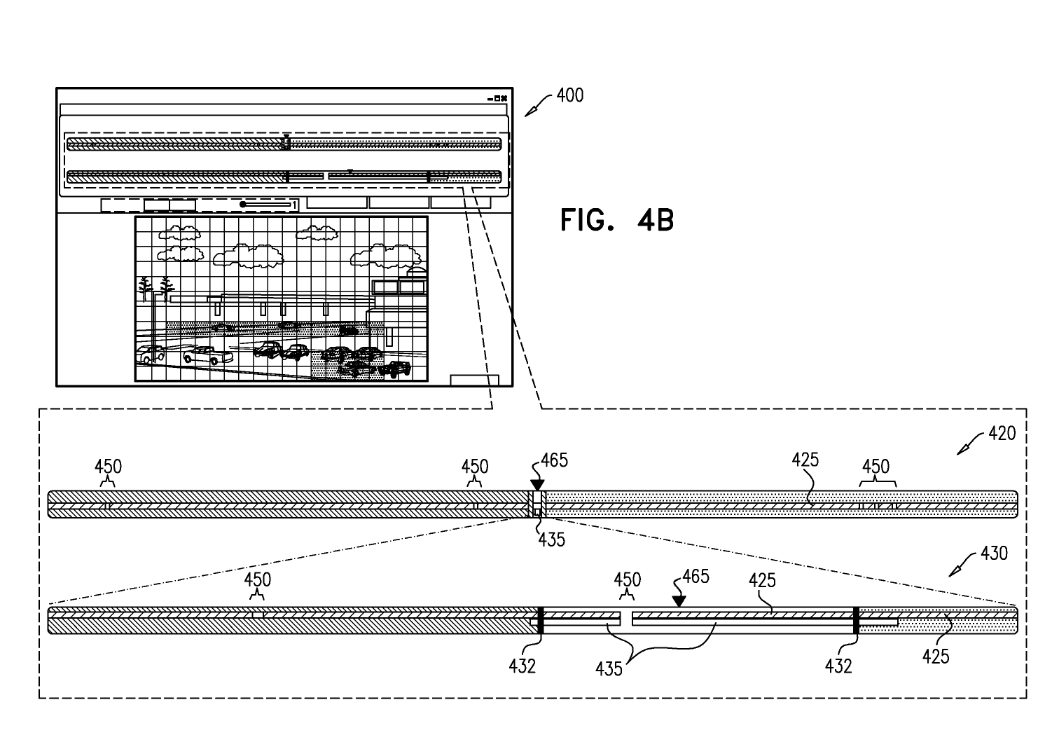

Reference is now made to FIGS. 4A and 4B. FIG. 4A is a simplified pictorial illustration of a third embodiment of the graphical user interface of FIG. 1. FIG. 4B is a detail of the full range timeline 420 and the detail range timeline 430 in the window 400 of FIG. 4A. Elements appearing in FIGS. 4A and 4B which were already discussed above in the discussion of FIGS. 2A, 2B, 3A and 3B, and are not relevant to the particular embodiment to be discussed with reference to FIGS. 4A and 4B, for the sake of brevity, are not mentioned in the discussion of FIGS. 4A and 4B. The full range timeline 420 of FIGS. 4A and 4B represents a timeline of duration of ten days 440. The full range timeline 420 shows a first type of data 425, such as recorded video data, within the full range timeline 420 indicating that video is available for the full ten days with several interruptions 450. In some cases, as discussed above, a video camera might not be available, or some other external factor, such as a network failure, may have prevented video from being recorded.

In addition to displaying the first type of data 425, the full range timeline 420 also displays a second type of data 435, i.e. metadata, corresponding to the video in the time range of the second timeline 430. The metadata may be the luminance values of the video frames in the video represented by the first timeline 420. Alternatively, the metadata may be any other appropriate metadata for the video as described above. Besides luminance values, other metadata could include a particular shape or color of objects that shows up in the video, for the application that tracks objects etc.

In the example depicted in FIGS. 4A and 4B, two hours thirty six minutes and three seconds are selected as the duration 455 of the detail range timeline 430. Then fifty minutes fifty-six seconds are selected on the detail timeline as user selected range. In response to the user selection of a time range for display in the detail range timeline 430, a motion grid 460 appears. Sliders 432 select a time range on the detail range timeline 430 in which motion detection is to occur. The motion grid 460 is a display of the video during the selected time range displayed in the second timeline 430 Motion grid 460 enables playing streaming video. There is a play head 465 (i.e. a triangle marker) displayed on the timeline. The play head 465 indicates the time of video frame displayed in motion grid 460. When there is a gap in the video recording, the video will skip to the next available video, and the play head will jump to its appropriate location on the timeline as well. It is appreciated that luminance itself, while useful as metadata, is not video content and therefore is not directly viewable. But on the full range timeline 420 and the detail range timeline 430, the user can see when the metadata is available or missing. The motion grid 460 enables a user to select particular boxes of the motion grid 460, for example, by clicking on those boxes with a mouse or other appropriate pointing device. In the example depicted in FIG. 4A, an area corresponding to a road 470, and an area of interest corresponding to a portion of a parking lot 480 are selected. Once these areas are selected, the user can click on Next 483 to start the motion detection engine, which analyzes the user selected grids to look for motions in these grids. Motion event thumbnails, similar to video snap shot thumbnails 260 and 270 (FIG. 2A) and 340, 350, and 360 (FIG. 3A) will appear, enabling further analysis of motion events which may be occurring in those thumbnails.

The process of selecting particular boxes of the motion grid 460 is referred to in the art as “painting”. Accordingly, FIG. 4A depicts selection controls 485 to facilitate selecting painting potions the motion grid 460, such as Paint All, Erase All, and Invert All, which may be used to modify the selected portion of the video display in the motion grid 460.

FIG. 4A also depicts additional controls 490 of the sort commonly used in the art, such as adjusting the sensitivity and threshold for motion detection.

Another example where the embodiment of FIGS. 4A and 4B may be of use would be in a museum where motion in front of a particular curated item in the museum might be monitored for security or other purposes. While motion in the area directly in front of curated item might be of interest, motion a meter to the left or the right of the curated item might be of less interest.

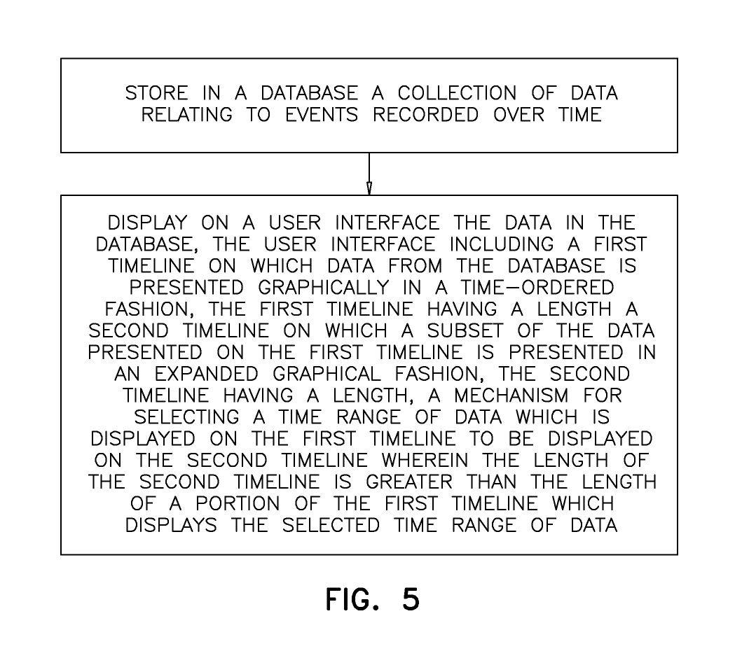

Reference is now made to FIG. 5, which is a flowchart diagram of a method for implementing an embodiment of the graphical user interface of FIG. 1. FIG. 5 is believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. An apparatus comprising:
a database comprising a collection of data relating to events recorded over time; and
a user interface for displaying the data in the database, the user interface comprising:
a first timeline on which data from the database is presented graphically in a time-ordered fashion, the first timeline having a first length; and
a second timeline on which a subset of the data presented on the first timeline is presented in an expanded graphical fashion, the second timeline having a second length;
a mechanism for selecting a time range of data which is displayed on the first timeline to be displayed on the second timeline;
wherein the second length is greater than the length of a portion of the first timeline which displays the selected time range of data.

2. The apparatus according to claim 1 wherein the second length is the same length as the first length.

3. The apparatus according to claim 1 wherein the data from the database comprises video data.

4. The apparatus according to claim 3 wherein the data from the database comprises metadata relating to the video data.

5. The apparatus according to claim 4 wherein the data comprises luminance data.

6. The apparatus according to claim 1 wherein the second timeline comprises at least two second timelines.

7. An method comprising:
storing in a database a collection of data relating to events recorded over time; and
displaying on a user interface the data in the database, the user interface comprising:
a first timeline on which data from the database is presented graphically in a time-ordered fashion, the first timeline having a first length; and
a second timeline on which a subset of the data presented on the first timeline is presented in an expanded graphical fashion, the second timeline having a second length;
a mechanism for selecting a time range of data which is displayed on the first timeline to be displayed on the second timeline;
wherein the second length is greater than the length of a portion of the first timeline which displays the selected time range of data.

8. The method according to claim 7 wherein the second length is the same length as the first length.

9. The method according to claim 7 wherein the data from the database comprises video data.

10. The method according to claim 9 wherein the data from the database comprises metadata relating to the video data.

11. The method according to claim 10 wherein the data comprises luminance data.

12. The method according to claim 7 wherein the second timeline comprises at least two second timelines.

13. An user interface comprising:
a first timeline on which data from a database is presented graphically in a time-ordered fashion, the first timeline having a first length; and
a second timeline on which a subset of the data presented on the first timeline is presented in an expanded graphical fashion, the second timeline having a second length;
a mechanism for selecting a time range of data which is displayed on the first timeline to be displayed on the second timeline;
wherein the second length is greater than the length of a portion of the first timeline which displays the selected time range of data.

14. The user interface according to claim 13, wherein the database comprises a collection of data relating to events recorded over time.

15. The user interface according to claim 13 wherein the user interface is operative to display the data in the database.

16. The user interface according to claim 13 wherein the second length is the same length as the first length.

17. The user interface according to claim 13 wherein the data from the database comprises video data.

18. The user interface according to claim 17 wherein the data from the database comprises metadata relating to the video data.

19. The method according to claim 18 wherein the data comprises luminance data.

20. The method according to claim 13 wherein the second timeline comprises at least two second timelines.
